(19) United States
(12) Patent Application Publication
(10) Pub. No.: US 2010/0277673 A1
(43) Pub. Date: Nov. 4, 2010

(54) DISPLAY DEVICE AND ILLUMINATION DEVICE

(75) Inventors: Christoph Gerard August Hoelen, Eindhoven (NL); Martinus Petrus Joseph Peeters, Eindhoven (NL); Jacobus Gerardus Boerekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/810,517

(22) PCT Filed: Dec. 19, 2008
(86) PCT No.: PCT/IB08/55462

§ 371 Date: Jun. 25, 2010

(30) Foreign Application Priority Data
Jan. 3, 2008 (EP) 08100033.3

(51) Int. Cl. G02F 1/13357

(52) U.S. Cl. 349/68

(57) ABSTRACT

The invention especially provides a display device (1) with a liquid crystal display (LCD) panel (10) and a backlight illumination device (20), wherein the backlight illumination device (20) comprises a light emitting diode package (200) arranged to generate white backlight (251), wherein the light emitting diode package (200) comprises a blue light emitting diode, LED (201), a green luminescent material (203) and a red luminescent material (204); and a transmissive ceramic layer (206), arranged to transmit at least part of the blue emission (249), wherein the transmissive ceramic layer (206) comprises at least part of the green luminescent.material (203) and/or the red luminescent material (204). The LED (201), the green luminescent material (203) and the red luminescent material (204) are arranged to generate white light (250) for backlighting the liquid crystal display panel (10).

### FIELD OF THE INVENTION

The invention relates to a display device comprising a liquid crystal display (LCD) panel and a backlight illumination device arranged to backlight the LCD panel, wherein the backlight illumination device comprises a light emitting diode package. The invention further relates to an illumination device comprising a light emitting diode package, especially a plurality of light emitting diode packages, arranged to emit light.

### BACKGROUND OF THE INVENTION

LCD panels with backlight illumination devices (shortly also indicated with “backlight” or “backlight unit” or “backlight device”) are known in the art. U.S. Pat. No. 7,052,152 for instance describes a display device comprising a housing comprising reflective surfaces and a top opening through which light is emitted for backlighting a liquid crystal display panel; an array of substantially identical light emitting diodes (LEDs) supported on a reflective bottom surface in the housing, each LED emitting light through top and side portions of the LED, the LEDs being separated from one another by a distance greater than the width of a single LED; and a diffuser above the LEDs for providing diffused light to an LCD panel. In an embodiment of U.S. Pat. No. 7,052,152, a backlight for an LCD display is provided, having a high efficiency, good color uniformity, and spatially and temporal adjustable luminance profile, for obtaining better contrast and lower power consumption at a low cost. The backlight uses an array of single color or white LEDs and a diffusing or luminescent material coated cover plate. To obtain a high efficiency, no additional optics is used in between the LEDs and the cover plate.

In U.S. Pat. No. 7,052,152, especially backlight configurations are used with only blue, UV, or near-UV LEDs; the color-converting luminescent material layer is on the cover plate. The cover plate may or may not be a diffuser, depending on the amount of diffusing performed by the luminescent material. The luminescent material layer is a uniform layer, consisting of one or more different type of luminescent materials. A green and a red luminescent material are used, but a yellow (YAG) luminescent material could be used as well. In U.S. Pat. No. 7,052,152, such configuration is considered to be attractive because the luminescent material is not on top of the LED die, and light emitted from the luminescent material to the rear of the backlight has a larger recycling efficiency than into the LED chips, due to the high reflectivity of the films, coatings, or reflective materials used in the backlight. In addition to the recycling efficiency, the luminescent material can be operated at a lower temperature and does not have chemical compatibility issues with the LED die, improving the efficiency and lifetime considerably. From a logistics point of view, this solution is attractive as well, as the blue backlight can be used for a large range of different displays, with different types of color filters, and only the luminescent material layer thickness and luminescent material concentration has to be optimized to fit a particular LCD.

### SUMMARY OF THE INVENTION

A disadvantage of the prior art systems may be that they do not easily allow a 2D dimming of the backlight, i.e. a reduction of the intensity of the backlight at a specific part of the backlight, whereas the ability of local dimming is an advantageous and desired property for backlights. A further disadvantage of prior art systems may be their relative low efficiency and/or small gamut.

Hence, it is an aspect of the invention to provide an alternative display device, as well as an alternative illumination device, especially suitable for use as backlight illumination device, which preferably further obviate one or more of above-described drawbacks. It is further an aspect of the invention to provide an illumination device, which may for instance be used for general lighting, with a high color rendering index (CRI).

Display Device

According to a first aspect, the invention provides a display device comprising a liquid crystal display (LCD) panel and a backlight illumination device arranged to backlight the LCD panel, wherein the backlight illumination device comprises a light emitting diode package arranged to generate white backlight, wherein the light emitting diode package comprises:

a. a light emitting diode (LED) arranged to emit blue emission;

b. a green luminescent material, arranged to absorb at least part of the blue emission and to emit green light, and a red luminescent material, arranged to absorb at least part of the blue emission, or at least part of the green light, or both at least part of the blue emission and the green light and to emit red light; and

c. a transmissive ceramic layer, arranged to transmit at least part of the blue emission, wherein the transmissive ceramic layer comprises at least part of the green luminescent material or at least part of the red luminescent material or comprises at least part of the green luminescent material and at least part of the red luminescent material, and wherein the LED, the green luminescent material and the red luminescent material are arranged to generate white light for backlighting the liquid crystal display panel.

Especially, the LED, the green luminescent material and the red luminescent material are arranged to generate white light per se (on or near the black body locus (BBL, Planckian locus)), or more especially, that in combination with the transmission characteristics of the LCD panel results in a front-of-screen (FOS) color point that is white and located on or near the black body locus when all pixels are in maximum transmissive mode), especially within about 15 SDCM (standard deviation of color matching) from the BBL, more especially within about 10 SDCM from the BBL.

In a specific embodiment, an LED package is proposed, comprising a blue emitting LED with a wavelength in the blue range, especially with a dominant emission wavelength in the range of about 430 to 455 nm, a transmissive ceramic layer, such as a ceramic (aluminum) garnet luminescent material plate comprising (LuₓY₁₋ₓ)₃Al₅O₁₂:Ce (indicated as LuₓY₁₋ₓAG) where x≧0, preferably x≧0.2, and a red luminescent material, such as a nitridosilicate luminescent material, e.g. CaAlSiN₃:Eu, wherein the red luminescent material may for instance be applied either (also) in the form of a transmissive ceramic plate, or for instance in the form of a luminescent powder layer, such as on the transmissive ceramic layer, or in a dome (or half sphere) of the LED, or as layer on the dome (or half sphere) of the LED.

Advantageously, the amount of luminescent material may be tuned such that the color point of the light emitted by back light illumination device has a correlated color temperature (CCT) between 7000 and 20000 K, and the color point is located close to or on the BBL (CCT of back light illumination device or front-of-screen of display device).

It advantageously and surprisingly appears that the excitation band of LuₓY₁₋ₓAG as ceramic layer is wide enough for this application, whereas the absorption band of LuₓY₁₋ₓAG powder is rather narrow and generally considered as too narrow for practical application in illumination. Herein, (LuₓY₁₋ₓ)₃Al₅O₁₂:Ce is further also indicated as “Lu garnet”, or “Lu aluminium garnet”, or “Lu containing garnet”, or Lu containing aluminium garnet, or “LuₓY₁₋ₓAG”, or, or “LuYAG”, or “LuAG”.

Application of a ceramic layer, such as LuₓY₁₋ₓAG in ceramic plate form, provides the advantage that the ceramic layer can be made more transparent than a luminescent powder layer; hence, the reflection of blue light (and green light) back towards the LED is much lower, resulting in lower optical losses.

Further, especially relating to LuₓY₁₋ₓAG ceramic layers: since the emission spectrum of the LuₓY₁₋ₓAG ceramic layer is surprisingly shifted to shorter wavelengths and may have a smaller spectral full width at half maximum (FWHM) (up to about 20 nm) relative to the emission of the LuₓY₁₋ₓAG luminescent powder, the color gamut of an LCD panel may be enlarged, both in the red and in the green region. In addition, the absorption of the LuₓY₁₋ₓAG ceramic layer is ideal for the application of blue pump emitters with a dominant emission wavelength in the range between 435 and 450 nm, where these pump devices show significantly higher wall plug efficiency (defined as the radiometric output power divided by the electrical input power of the device), than for emission with a dominant wavelength above 455 nm (where the latter is preferred to pump e.g. YAG (Y₃Al₅O₁₂:Ce) phosphors that show a maximum absorption at a dominant pump wavelength around 465 nm).

Using a transparent red or green or both red and green emitting ceramic layer in the LED package may therefore result in a higher system efficacy because of the higher light extraction from the package and/or a larger color gamut, than what can be obtained with YAG (either in the form of a luminescent powder or in the form of a ceramic layer) or than what can be obtained with LuₓY₁₋ₓAG in powder form. Further, lower temperature dependence than in backlight systems comprising red, green and blue intrinsic emitters (especially red, green and blue LEDs) can be achieved because blue emitters (i.e. blue LEDs) show the lowest dependence on temperature. Although remote luminescent material systems are known to be very efficient, the application thereof requires relatively cheap luminescent materials to be applied because of the relative large amount of luminescent material that is needed for these systems (see for instance U.S. Pat. No. 7,052,152). In such systems, LuₓY₁₋ₓAG powder might be a good candidate in view of efficiency, but the gamut is still relatively limited. With the (backlight) illumination device according to the invention, a color gamut area relative to the NTSC gamut in CIE 1976 u′ v′ coordinates of at least 85% can advantageously be easily achieved with several commercially available LCD panels.

As will be clear to the person skilled in the art, the backlight illumination device of the display device may comprise one or more LED packages, especially a plurality of LED packages. The number of LED packages applied may depend upon the dimensions of the LCD panel.

(Backlight) Illumination Device

The LED package may not only suitably be applied in a backlight illumination device in a display device, but may also be applied as illumination device per se. Hence, according to a further aspect of the invention, an illumination device especially designed for backlighting is provided, and according to a further aspect, an illumination device (per se) is provided. Such illumination device, either for backlighting (i.e. the backlight illumination device, but also for e.g. backlighting of translucent posters in poster boxes), or for other lighting purposes, e.g. for task lighting, for spot lighting, for area lighting, or for direct view lighting panels, is herein further indicated as “illumination device”. The term “backlight illumination device” is however sometimes used to stress that an embodiment of an illumination device in or for a display device is described.

Therefore, according to an aspect, the invention provides an illumination device comprising one or more, and especially a plurality of, light emitting diode packages arranged to emit light, wherein (at least one of) the light emitting diode package(s) comprises:

a. a light emitting diode (LED) arranged to emit blue emission;

b. green luminescent material, arranged to absorb at least part of the blue emission and to emit green light, and a red luminescent material, arranged to absorb at least part of the blue emission, or at least part of the green light, or both at least part of the blue emission and at least part of the green light, and to emit red light; and

c. a transmissive ceramic layer, arranged to transmit at least part of the blue emission, wherein the transmissive ceramic layer comprises at least part of the green luminescent material or at least part of the red luminescent material or comprises at least part of the green luminescent material and at least part of the red luminescent material, and wherein the LED, the green luminescent material and the red luminescent material are arranged to generate light, especially white light. Especially, in an embodiment all light emitting diode packages of the one or more or of the plurality of light emitting diode packages have the features according to a-c as defined herein for at least one of the light emitting diode packages.

2D or 1D Dimming

In a specific embodiment, the (backlight) illumination device further comprises one or more, and especially a plurality of light emitting diode packages, and a controller, wherein the controller is arranged to control the intensity or color or both intensity and color of the white (back)light of the individual or groups of individual light emitting diode package(s) of the one or more or the plurality of light emitting diode package(s).

In prior art LCD backlight illumination devices comprising separate color emitting light sources (e.g. red, green and blue LEDs) that require mixing of the different colors outside the light emitters to create a uniform color point across the exit window of the backlight illumination device, the finite overlap between the luminance patterns of the light sources causes color point deviations in the exit window of the backlight illumination device when locally dimming or boosting one or more light emitters. Unlike some of the prior art LCD backlight illumination devices which use separate blue, red and green sources, the (backlight) illumination device of the invention allows in this way a local dimming of the (backlight) illumination device, with decreased overlap between the luminance patterns associated with the individual or groups of individual LED packages which enables deeper local dimming than what is possible with a larger overlap between the mentioned luminance patterns, and without substantially affecting the color point distribution of the (backlight) illumination device. Therefore, with the (backlight) illumination device of the invention, 2D dimming and/or boosting may be possible.

As a further aspect of the invention, also 1D dimming or boosting capability may be improved with the (backlight) illumination device of the invention, both in “direct lit” and in “edge lit” (backlighting) configurations, thanks to the improved color uniformity.

Triband Principle

In the invention, amongst others the triband principle is applied, i.e. at least a blue emitter, a green emitter and a red emitter are applied. Hence, more in general, according to yet a next aspect, the invention provides the use of

a. a source of blue light arranged to emit blue emission;

b. a green luminescent material, arranged to absorb at least part of the blue emission and to emit green light, and a red luminescent material, arranged to absorb at least part of the blue emission, or at least part of the green light, or both at least part of the blue emission and at least part of the green light, and to emit red light; and

c. a transmissive ceramic layer, arranged to transmit at least part of the blue emission, wherein the transmissive ceramic layer comprises at least part of the green luminescent material or at least part of the red luminescent material or comprises at least part of the green luminescent material and at least part of the red luminescent material; to generate light, especially white light.

Color & Color Temperature

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL, especially within about 10 SDCM from the BBL, even more especially within about 5 SDCM from the BBL. Herein, the term white light for backlight illumination devices may especially refer to light that in combination with the transmission characteristics of the LCD panel results in a front-of-screen (FOS) color point that is white and is located on or near (i.e. especially within about 15 SDCM from) the black body locus when all pixels of the LCD are in maximum transmissive mode.

Especially, for display devices, the color point is selected to provide a front of screen color point on or close to the BBL. Preferably, in combination with the color filters of an LCD panel the resulting (front of screen) correlated color temperature may be near 9000 K on (or near) the BBL, such as in the range of 7000-12000 K, more preferably in the range 8000-10000 K.

For lighting applications other than back lighting, the correlated color temperature of the white light generated by the illumination device may be in the range of about 2700-6500 K; especially about 2700 K (such as about 2500-2800 K), about 3000 K (such as about 2800-3300 K), about 4000 K (such as about 3500-4500 K) or about 6500 K (such as about 5500-7500 K).

The term “blue light” or “blue emission” especially relates to light having a wavelength in the range of about 410-490 nm. The term “green light” especially relates to light having a wavelength in the range of about 500-570 nm. The term “red light” especially relates to light having a wavelength in the range of 590-650 nm.

These terms do not exclude that especially the luminescent material may have a broad band emission having emission with wavelength(s) outside the range of about 500-570 nm and about 590-650 nm, respectively. However, the dominant wavelength of emissions of such luminescent materials (or of the LED, respectively) will be found within herein given ranges, respectively. Hence, the phrase “with a wavelength in the range of” especially indicates that the emission may have a dominant emission wavelength within the specified range.

Non-Exhaustive List of LED Package Arrangements

The terms “LED package” or “light emitting diode package” herein refer to a unit comprising an LED, especially a blue light emitting LED, including a ceramic luminescent material, arranged downstream from the LED, and one or more other luminescent materials. These terms may refer to one single LED package, but may in an embodiment also refer to a plurality of LED packages. Such package is a unit that is able to emit (white) light, due to the combination of LED light and luminescent material light. In general, the LED may further comprise a lens, such as a silicone rubber (half) sphere or dome, characterized in that is has a convex surface that emits the light, and that may also be used to protect the LED and/or increase the light extraction from the LED. Such lens may comprise dispersed luminescent material.

The invention is in an aspect also directed to an LED package per se.

The term “downstream” is known to the person skilled in the art, and may herein refer to a location relative to the LED and in the illumination beam of the LED. A luminescent material downstream of the LED may receive at least part of the LED emission (assuming for instance an unimpeded illumination beam), and may convert at least part of the LED emission into light with another wavelength.

Herein, the term “LED emission” refers to the light of the LED when the LED is operating. The terms “LED emission”, “LED light”, “LED illumination light” are equal. Further, an LED emitting blue light may shortly be indicated as “blue LED”, “blue pump”, or “blue LED pump” etc. Likewise, this applies to LEDs emitting other colors during use.

The phrase “wherein at least one of the pluralities of LED packages comprises . . . ”, refers to embodiments wherein one or more, and in a specific embodiment all, of the LED packages comprises . . . .

To obtain the white light, such as for the illumination device, a plurality of LED package arrangements are possible. Below follows an enumeration of possible embodiments, which is a non-exhaustive enumeration.

In an embodiment, the LED package comprises a blue LED, a red luminescent material and ceramic layer comprising a green luminescent material. The red luminescent material may in variants (i) be dispersed in the lens (or dome), may be (ii) arranged as layer on the lens, may be (iii) provided as layer on the ceramic layer at the downstream side of the ceramic layer (i.e. the side of the ceramic layer not directed to the LED), may be (iv) provided as layer on the ceramic layer at the upstream side of the ceramic layer (i.e. the side of the ceramic layer directed to the LED), may also be (v) provided as ceramic layer at the downstream side of the ceramic layer (i.e. the side of the ceramic layer not directed to the LED), may also be (vi) provided as ceramic layer at the upstream side of the ceramic layer (i.e. the side of the ceramic layer directed to the LED).

In another embodiment, the LED package comprises a blue LED, a green luminescent material and ceramic layer comprising a red luminescent material. The green luminescent material may in variants (vii) be dispersed in the lens, may be (viii) arranged as layer on the lens, may be (ix) provided as layer on the ceramic layer at the downstream side of the ceramic layer (i.e. the side of the ceramic layer not directed to the LED), may be (x) provided as layer on the ceramic layer at the upstream side of the ceramic layer (i.e. the side of the ceramic layer directed to the LED), may also be (xi) provided as ceramic layer, at the downstream side of the ceramic layer (i.e. the side of the ceramic layer not directed to the LED) (see also vi above), may also be (xii) provided as ceramic layer, at the upstream side of the ceramic layer (i.e. the side of the ceramic layer directed to the LED) (see also v above).

In again a further embodiment, the LED package may (xiii) comprise a blue LED and a ceramic layer comprising a red luminescent material and a green luminescent material.

Combinations of variants are also possible. Further, the fact that the triband principle is applied does not exclude the use of further luminescent materials, for instance to increase the gamut and/or the CRI and/or the efficacy. Especially preferred are the embodiments with the red luminescent material provided upstream from the ceramic layer (e.g. iv, vi) as this may result in an enhanced color gamut of the display device or in an enhanced system efficacy, or in an enhanced color rendering of the illumination device.

In a specific embodiment, the LED is arranged to generate blue light with a wavelength in the range of about 430-455 nm, especially in the range of about 440-450 nm. As mentioned above, this especially implies that the dominant emission wavelength is in the indicated wavelength range. The emission of the source of blue light, especially an LED arranged to emit blue emission, will in general be a band emission with a band width at half maximum in the range of about 20-80 nm width.

In an embodiment, especially assuming the ceramic layer to comprise the green luminescent material, the red luminescent material is arranged, relative to the LED, downstream of the LED and (but) upstream of the transmissive ceramic layer. In this way, the red luminescent material is substantially not able to absorb green light (emitted by the green luminescent material). Therefore, in an embodiment, the red luminescent material is arranged upstream of the green luminescent material.

In a specific embodiment, the transmissive ceramic layer has an upstream side coating comprising the red luminescent material. Between the transmissive ceramic layer and the coating may optionally be one or more further layers. The one or more further layers may advantageously have a spectral dependence in their optical properties, e.g. to reflect a specific part of the spectrum. This embodiment also comprises an embodiment wherein the LED has a downstream coating comprising the red luminescent material, wherein the red luminescent material is upstream of the green luminescent material. Between the LED and the downstream coating may optionally be one or more further layers. The one or more further layers may advantageously have a spectral dependence in their optical properties.

In general, in the LED package of the invention, the ceramic layer may be arranged within a distance from the light emitting surface of the LED in the range of about 0-20 mm, especially about 0-15 mm, more preferably in the range of about 0 and 5 mm. About 0 mm herein indicates contact between the light emitting surface of the LED and of the light receiving surface of the ceramic layer.

Luminescent Materials and Transmissive Ceramics

Especially preferred luminescent materials are selected from garnets and nitrides, especially doped with trivalent cerium or divalent europium, respectively. Embodiments of garnets especially include A₃B₅O₁₂ garnets, wherein A comprises at least lutetium and wherein B comprises at least aluminium. Such garnet may be doped with cerium (Ce), with praseodymium (Pr) or a combination of cerium and praseodymium. Especially, B comprises aluminium (Al), however, B may also be partly comprise gallium (Ga) and/or scandium (Sc) and/or indium (In), especially up to about 10% of Al (i.e. the B ions essentially consist of 90 or more mole % of Al and 10 or less mole % of one or more of Ga, Sc and In); B may especially comprise up to about 10% gallium. In another variant, B and O may at least partly be replaced by Si and N. The element A may especially be selected from the group consisting of yttrium (Y), gadolinium (Gd), terbium (Tb) and lutetium (Lu). Especially, the garnet luminescent materials for use in the invention comprise at least Lu. Further, Gd and/or Tb are especially only present up to an amount of about 20% of A. In a specific embodiment, the garnet luminescent material comprises (Y₁₋ₓLuₓ)₃B₅O₁₂:Ce, wherein x is larger than 0 and equal to or smaller than 1, especially wherein x≧0.2, and more especially wherein x≧0.8. In general, the higher the Lu content, the larger the color gamut. Depending on the color temperature, the maximum CRI is found at specific Y/Lu ratios. In particular at higher color temperatures a higher Lu content is preferred, where for lower color temperatures a higher Y content is preferred for maximum CRI.

The term “:Ce”, indicates that part of the metal ions (i.e. in the garnets: part of the “A” ions) in the luminescent material is replaced by Ce. For instance, assuming (Y₁₋ₓLuₓ)₃Al₅O₁₂:Ce, part of Y and/or Lu is replaced by Ce. This notation is known to the person skilled in the art. Ce will replace A in general for not more than 10%; in general, the Ce concentration will be in the range of 0.1-4%, especially 0.1-2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as known to the person skilled in the art.

In general, the formula for a preferred embodiment of the luminescent garnet material can be described as (Y_{1-q-r}Lu_{q-s}Ceᵣ₊ₛ)₃B₅O₁₂. Herein, 0<r+s≦0.1, 0<q−s<1, 0<q≦1, especially 0.1≦q≦1, more especially 0.2≦q≦1, even more especially 0.8≦q≦1, and 0≦q+r+s≦1; B is as defined above. The term “r+s” may be selected since when preparing the luminescent material, for compensating the introduction of cerium, the amount of lutetium can correspondingly be reduced, the amount of yttrium can correspondingly be reduced, or the total amount of yttrium and lutetium can correspondingly be reduced. The person skilled in the art understands that the same applies to garnets comprising gadolinium and/or terbium. Especially the Lu containing garnets can be used as green luminescent material. As mentioned above, in a specific embodiment, Y may further partially be replaced by Gd and/or Tb and/or Pr).

The red luminescent material may in an embodiment comprise one or more materials selected from the group consisting of (Ba,Sr,Ca)S:Eu, CaAlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation, especially in the range of about 0.5-10, more especially in the range of about 0.5-5% relative to the cation(s) it replaces. The term “:Eu”, indicate that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba.

The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, calcium and strontium, more especially calcium. Here, Eu is introduced and replaces at least part of M (i.e. one or more of Ba, Sr, and Ca).

Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50-100%, especially 50-90% Ba and 50-0%, especially 50-10% Sr, such as Ba_{1.5}Sr_{0.5}Si₅N₈:Eu (i.e. 75% Ba; 25% Sr). Here, Eu is introduced and replaces at least part of M i.e. one or more of Ba, Sr, and Ca).

Transmissive ceramic layers or luminescent ceramics, and their method of preparation, are known in the art. It is for instance referred to U.S. patent application Ser. No. 10/861,172 (US2005/0269582), to U.S. patent application Ser. No. 11/080,801 (US2006/0202105), or to WO2006/097868, to WO2007/080555, to US2007/0126017 and to WO2006/114726. The documents, and especially the information about the preparation of the ceramic layers provided in these documents, are herein incorporated by reference.

The ceramic layers may especially be self-supporting layers, and may be formed separately from the semiconductor device, then in an embodiment be attached to the finished semiconductor device or in another embodiment be used as a growth substrate for the semiconductor device. The ceramic layers may be translucent or transparent, which may reduce the scattering loss associated with non-transparent wavelength converting layers such as conformal luminescent material layers (i.e. powder layers). Luminescent ceramic layers may be more robust than thin film or conformal luminescent material layers. In addition, since luminescent ceramic layers are solid, it may be easier to make optical contact to additional optical elements such as lenses and secondary optics, which are also solid.

A ceramic luminescent material may in an embodiment be formed by heating a powder luminescent material at high temperature until the surfaces of the luminescent material particles begin to soften and a liquid surface layer forms. The partially melted particle surfaces promote interparticle mass transport which leads to the formation of a “neck” where the particles join. The redistribution of the mass that forms the neck causes shrinkage of the particles during sintering and produces a rigid agglomerate of particles. Uniaxial or isostatic pressing steps, and vacuum sintering of the preformed “green body” or the sintered predensified ceramic may be necessary to form a polycrystalline ceramic layer with low residual internal porosity. The translucency of the ceramic luminescent material, i.e. the amount of scattering it produces, may be controlled from high opacity to high transparency by adjusting the heating or pressing conditions, the fabrication method, the luminescent material particle precursor used, and the suitable crystal lattice of the luminescent material. Besides luminescent material, other ceramic forming materials such as alumina may be included, for example to facilitate formation of the ceramic or to adjust the refractive index of the ceramic. Polycrystalline composite materials that contain more than one crystalline component or a combination of crystalline and amorphous or glassy components can also be formed, for example, by cofiring two individual powder luminescent materials such as an oxonitridosilicate luminescent material and a nitridosilicate luminescent material.

In a specific embodiment, a ceramic luminescent material may be formed by traditional ceramic processes. A “green body” is formed by dry pressing, tape casting, slib casting, amongst others. This green body is then heated at elevated temperature. During this sintering stage, neck formation and interparticle mass transport take place. This causes a strong reduction of the porosity and consequently shrinkage of the ceramic body. Residual porosity depends on the sintering conditions (temperature, heating, dwell, atmosphere). Hot uniaxial or hot isostatic or vacuum sintering of the preformed “green body” or the sintered predensified ceramic may be necessary to form a polycrystalline ceramic layer with low residual internal porosity.

Examples of luminescent materials that may for instance be formed into luminescent ceramic layers include aluminium garnet luminescent materials with the general formula (Lu_{1-x-y-a-b}YₓGd_{y})₃(Al_{1-z-c}Ga_{z}Si_{c})₅O_{12-c}N_{c}:CeₐPr_{b} wherein 0<x<1, 0≦y≦1, 0≦z≦0.1, 0<a≦0.2, 0≦b≦0.1, and 0≦c<1 such as Lu₃Al₅O₁₂:Ce³⁺, Y₃Al₅O₁₂:Ce³⁺ and Y₃Al_{4.8}Si_{0.2}O_{11.8}N_{0.2}:Ce³⁺ which emit light in the yellow-green range; and (Sr_{1-x-y}BaₓCa_{y})_{2-z}Si₅₋ₐAlₐN₈₋ₐOₐ:Eu_{z}²⁺ wherein 0≦a<5, 0≦x≦1, 0≦y≦1, 0≦x+y≦1 and 0<z≦1 such as Sr₂Si₅N₈:Eu²⁺, which emit light in the red range. Suitable Y₃Al₅O₁₂:Ce³⁺ ceramic slabs may be purchased from Baikowski International Corporation of Charlotte, N.C. Other green, yellow, and red luminescent materials may also be suitable, including (Sr_{1-a-b}Ca_{b}Ba_{c})SiₓN_{y}O_{z}:Euₐ²⁺ (a=0.002-0.2, b=0.0-0.25, c=0.0-0.25, x=1.5-2.5, y=1.5-2.5, z=1.5-2.5) including, for example, SrSi₂N₂O₂:Eu²; (Sr₁₋ᵤ₋ᵥ₋ₓMgᵤCaᵥBaₓ)(Ga_{2-y-z}Al_{y}In_{z}S₄):Eu²⁺ including, for example, SrGa₂S₄: Eu²⁺; (Sr_{1-x-y}BaₓCa_{y})₂SiO₄:Eu²⁺ including, for example SrBaSiO₄:Eu²⁺; Ca₁₋ₓSrₓS:Eu²⁺ wherein 0<x<1 including, for example, CaS:Eu²⁺ and SrS:Eu²⁺; (Ca_{1-x-y-z}SrₓBa_{y}Mg_{z})₁₋ₙ(Al_{1-a+b}Bₐ)Si_{1-b}N_{3-b}O_{b}:REₙ, wherein 0≦x≦1, 0≦y≦1, 0≦z≦1, 0≦a≦1, 0≦b≦1 and 0.002≦n≦0.2 and RE is selected from europium(II) and cerium(III) including for example CaAlSiN₃:Eu²⁺ and CaAl_{1.04}Si_{0.96}N₃:Ce³⁺; and Mₓ^{V+}Si₁₂₋₍ₘ₊ₙ₎Alₘ₊ₙOₙN₁₆₋ₙ, with x=m/v and M being a metal, preferably selected out of the group comprising Li, Mg, Ca, Y, Sc, Ce, Pr, Nd, Sm, Eu, Gd, Tb, Dy, Ho, Er, Tm, Yb, Lu or mixtures thereof including, for example, Ca_{0.75} Si_{8.625}Al_{3.375}O_{1.375}N_{0.625}:Eu_{0.25}.

Unlike a luminous powder film, which comprises luminescent material particles with large optical discontinuities in refractive index with the binder or surrounding material, and unlike a monocrystalline luminescent body, which optically behaves as a single, large luminescent material particle with no optical discontinuities, a polycrystalline luminescent ceramic may behave as tightly packed individual luminescent material particles, such that there are (substantially) only small optical discontinuities at the interface between different luminescent material particles. By reducing the optical discontinuities the optical properties of a monocrystalline luminescent body are approached. Thus, luminescent ceramics like LuAG (which exhibits a cubic crystal structure that enables transparency) are optically almost homogenous and have the same refractive index as the luminescent material forming the luminescent ceramic. Unlike a conformal luminescent material layer or a luminescent material layer disposed in a transparent material such as a resin, a luminescent ceramic generally requires no binder material (such as an organic resin or epoxy) other than the luminescent material itself, such that there is very little space or material of a different refractive index between the individual luminescent material particles. As a result, a luminescent ceramic may be transparent or translucent, unlike a conformal luminescent material layer that exhibits more and/or larger optical discontinuities in the layer.

As mentioned above, in specific embodiment, the transmissive ceramic layer comprises a cerium containing garnet ceramic, especially the A₃B₅O₁₂:Ce garnet ceramic (as also defined above), wherein A comprises at least lutetium and wherein B comprises at least aluminium, more especially a (Y₁₋ₓLuₓ)₃B₅O₁₂:Ce garnet ceramic, wherein x is larger than 0 and equal to or smaller than 1. Especially, B is aluminium. The phrase “the transmissive ceramic layer comprises a cerium containing garnet ceramic” especially relates to a ceramic which substantially consists or entirely consists of such material (here in this embodiment garnet).

Transmissive ceramic layers are known in the art, see also above. The transparency of a transparent ceramic layer may be defined using the transmission as a measure for the scattering properties of the layer. The transmission is especially defined as the ratio of the amount of light transmitted (also after internal reflection and scattering) through by the ceramic layer away from a diffuse light source and the amount of light emitted from the diffuse light source that irradiates the ceramic layer. The transmission can for instance be obtained by mounting a ceramic layer, with for instance a thickness in the range of 0.07-2 mm, such as about 120 micrometer, in front of a diffuse emitter of red light with a dominant wavelength between 590 and 650 nm, and then measuring the above defined ratio.

A transparent ceramic layer may for instance be characterized in that the transmission is larger than 50%, preferably larger than 70%, even more preferably larger than 80%. In a specific embodiment, the ceramic layer has a transmission in the range of 55-95% for red light with a wavelength selected from the range of 590-650 nm under diffuse (Lambertian) illumination with the red light. The term “transmissive” herein may in an embodiment refer to transparent and may in another embodiment refer to translucent. These terms are known to the person skilled in the art.

Specific Embodiments for General Illumination

In addition to the embodiments described above, some specific embodiments are now indicated which can especially (but not exclusively) be used for (non-backlight) illumination purposes, such as general lighting, target lighting, etc.

In such embodiments, a (LuₓY₁₋ₓ₎₃Al₅O₁₂:Ce ceramic phosphor is preferred with about 0.2≦x≦1, in combination with a red emitting phosphor (either as ceramic plate or based on powder application) with a dominant peak wavelength in the range from about 615 to 645 nm, more preferably in the range from about 620 to 635 nm. Hence, the red luminescent material has in an embodiment an emission with a dominant emission wavelength selected from the range of 620-635 nm.

For correlated color temperatures in the range from about 2500 to 3300K, a Lu concentration with about 0.25≦x≦0.8 is preferred. For correlated color temperatures in the range from about 3500 to 4500K, a Lu concentration with about 0.3≦x≦0.8 is preferred. For correlated color temperatures in the range from about 5500 to 7500K, a Lu concentration with about 0.4≦x≦1 is preferred; a preferred concentration is about 0.5≦x≦0.9.

Referring to the above defined formula A₃B₅O₁₂:Ce, the term 0.25≦x≦0.8 describes the embodiment wherein 25-80 mole % of the A ion or A positions in the lattice are occupied by Lu ions; the other 75-20 mole % may be occupied by Y (see also above). Ce replaces part of one or more of these ions (Lu and Y). Optionally, part of Lu and/or Y may also be replaced by Tb and/or Pr.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a schematically depicts a display device with an LCD panel with a direct lit (i.e., the light emitting devices illuminate the exit window of the backlight illumination device without substantially spreading the light with the use of a light guide or light pipe based on total internal reflection) backlight illumination device according to an embodiment of the invention; FIG. 1b schematically depicts a display device with an LCD panel with an edge lit backlight illumination device according to a further embodiment of the invention. FIG. 1c schematically depicts an illumination device according to an embodiment of the invention, which might be used as illumination device per se or as backlight illumination device. These schematically depicted and below described embodiments are not limiting. Other configurations known to the person skilled in the art are also possible.

FIGS. 2a-2j schematically depict a non-limiting number of the possible configurations of the LED package according to embodiments of the invention;

FIG. 3 depicts an efficacy vs. gamut performance for a number of blue, green and red emitter combinations;

FIG. 4 depicts the performance of a LC display; with Lu₃Al₅O₁₂:Ce as green luminescent ceramic layer and with CaAlSiN₃:Eu as red luminescent material;

FIG. 5 depicts the performance of a LC display; with (Lu_{0.2}Y_{0.8})₃Al₅O₁₂:Ce as green luminescent ceramic layer and with CaAlSiN₃:Eu as red luminescent material;

FIG. 6 schematically depicts an embodiment of the LED package of an embodiment of the invention in more detail;

FIGS. 7a-b depict color rendering and efficacy as function of the emission wavelength of a Lu garnet ceramic layer and compared with a Lu garnet luminescent powder.

### DESCRIPTION OF PREFERRED EMBODIMENTS

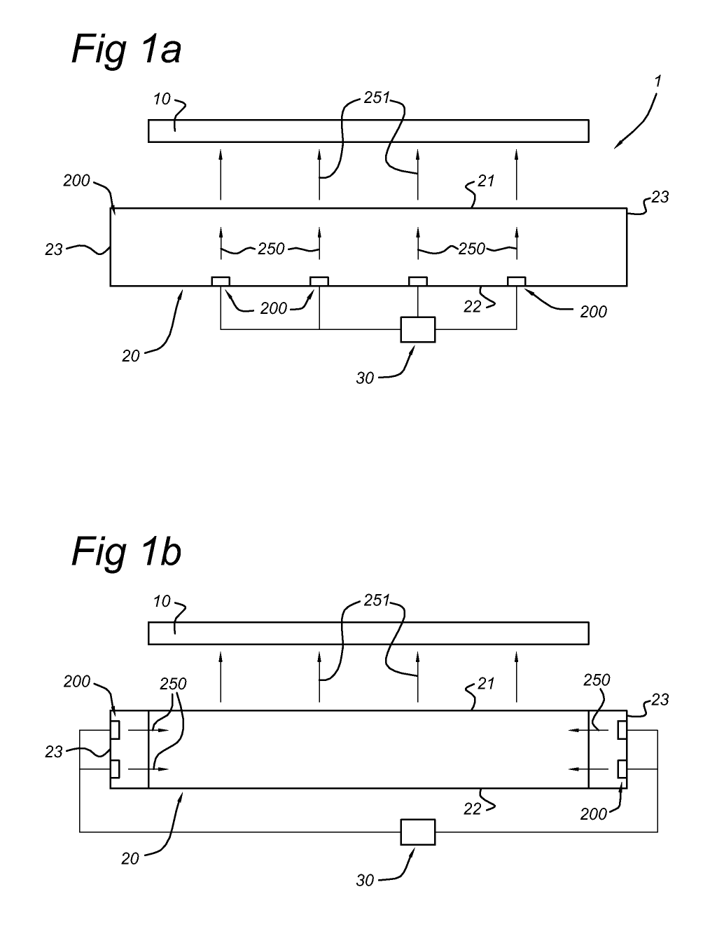

FIGS. 1a and 1b schematically depict embodiments of a LCD display device 1 with a back light illumination device 20, arranged to backlight an LCD display 10. Optional intermediate layers, such as optical filters, diffusers, brightness enhancement films, polarizers, etc., known to the person skilled in the art, are not indicated in this schematic drawing. The backlight illumination device 20 may generate white light 251 for backlighting the LCD display 10. The back light illumination device 20 comprises an exit window 21, arranged to allow light 250 generated in the backlight illumination device 20 escapes therefrom and illuminate the LCD display 10. The (backlight) illumination device 20 comprises one or more LED packages 200, especially a plurality of LED packages 200, such as in the order of 1-20, like 2-20 (for small LCD panels, e.g. for mobile applications), 4-50 (for medium size panels, e.g. for automotive centre console LCD panels), or 20-1000 (for large panels, e.g. LCD TV panels) LED packages 200. The LED package(s) 200 may be arranged at a rear wall 22 (“direct lit”) (as schematically depicted in FIG. 1a), opposite of the exit window 21, but may also be applied at side walls 23 (“edge lit”) (as schematically depicted in FIG. 1b). Also combinations of such variants are possible.

The LED package(s) 200 may further comprise or be combined with secondary optics (not depicted) to redistribute the light emitted from the LED package(s) 200. In a specific embodiment, the backlight illumination device 20 comprises exit window 21 and rear wall 22, wherein the rear wall 22 is opposite of exit window 21, and substantially parallel with exit window 21, and wherein the LED packages(s) 200 is (are) arranged at the rear wall 22 and are arranged to provide emission that escapes from backlight illumination device 20 via the exit window 21 (see especially FIG. 1a). The exit window 21 is in general a transparent material, which may further comprise one or more filter coatings and/or other optically active layers (such as a diffuser (diffuser layer)). Therefore, the white or substantially white light generated by the LED packages 200, indicated with reference number 250, may be modified by the optionally filter coatings and or the exit window material into white light 251. Further, the rear wall 22 and side walls 23 in general comprise reflective materials, such as reflective coatings.

In an embodiment, as depicted in FIGS. 1a-1c, the (backlight) illumination device 20 further comprises a controller to control the intensity or the color, or both, of the emission light of one or more of the individual LED packages 200, especially of all of the LED packages 200.

FIG. 1c schematically depicts an illumination device 120, which may further be identical to the backlight illumination device 20 of FIG. 1a. Illumination device 120 may in an embodiment also generate non-white light, or white light with variable correlated color temperature. In the schematic embodiment of FIG. 1c, the illumination device 120 by way of examples comprises LED packages 200 arranged to provide direct lighting (similar to the embodiment depicted in FIG. 1a) and LED packages 200 arranged to provide edge light (similar to the embodiment depicted in FIG. 1b). Either one of these options is of course also possible.

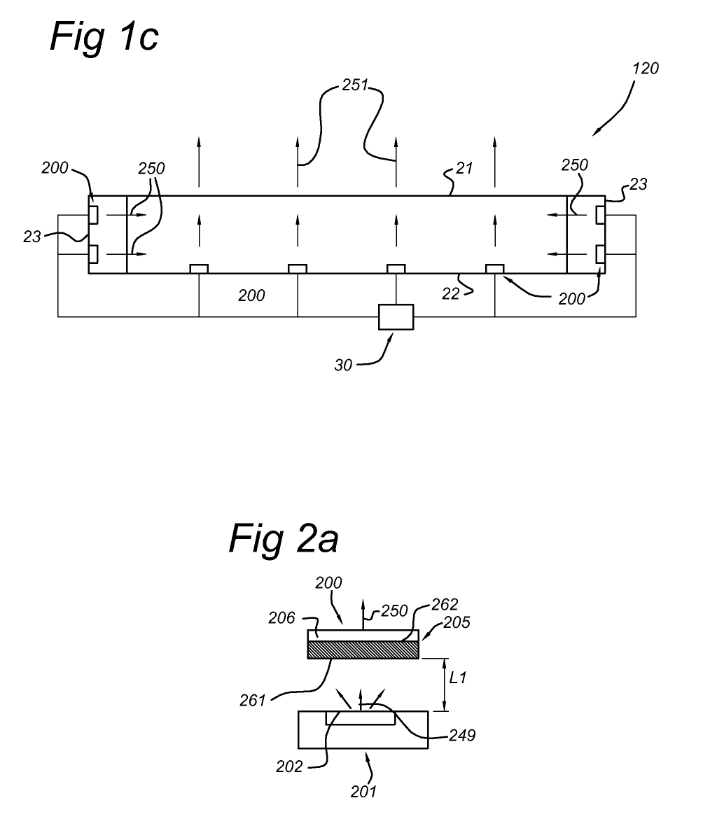

FIGS. 2a-2j schematically depict a number of possible configurations of the LED package 200. The LED package 200 comprises an LED 201, with a light emitting surface 202. Downstream of the light emitting surface 202 (i.e. of the chip or die), either on top of this surface, or remote, the luminescent materials are arranged, to absorb at least part of the LED emission and emit green and red light (and optionally also other colors). All FIGS. 2a-2j relate to embodiments wherein a ceramic layer 205 is applied. This ceramic layer 205 is arranged to receive at least part of the light of the LED 201 and has a light receiving surface 261. Especially, the ceramic layer 205 is arranged to receive substantially all of the LED emission. The light receiving surface 261 is arranged to be directed to the light emitting surface 202 of the LED 201.

FIG. 2a schematically depicts for explanation purposes an embodiment of the LED package 200 according to the invention. The light emitting diode 201, arranged to emit blue emission, indicated with reference number 249, and ceramic layer 205 are arranged that ceramic layer 205 receives substantially all LED light 249. This may be achieved by providing an embodiment of the ceramic layer 205, wherein the ceramic layer 205, i.e. a light receiving surface 261, is attached to the light emitting surface 202 and has a substantially same or larger area than the light emitting surface 202 of the LED 201.

The ceramic layer 205 may also be arranged more remote from the light emitting surface 202, i.e. at a distance L1 from the light emitting surface 201, where the distance L1 is preferably in the range between 1 and 15 mm, more preferably in the range between 2 and 10 mm. In such embodiment, the light receiving surface 261 of the ceramic layer 205 may have a larger surface area than the light emitting surface 202. When the ceramic layer 205 is not remote, L1 will essentially be 0 mm.

The ceramic layer 205 may convert at least part of the emission light 249 into light of another color, for instance green light. In this embodiment, the light receiving surface 261 may receive substantially all emission 249 of the LED 201.

Upstream or downstream (but also within the ceramic layer 205) another luminescent material may be present. In the embodiment of FIG. 2a, this is indicated with a luminescent material layer 206, but this is only one of the embodiments, see below. The other luminescent material may also convert at least part of the LED emission light 249 of the LED. The luminescent layer 206 or the ceramic layer 205 or both may comprise the green luminescent material. Likewise, the luminescent layer 206 or the ceramic layer 205 or both may comprise the red luminescent material. Light escapes from the ceramic layer 205 via a light emitting surface 262.

In this way, a source of blue light, such as the blue emitting LED 201, arranged to emit blue emission 249; a green luminescent material, arranged to absorb at least part of the blue emission and to emit green light, and a red luminescent material, arranged to absorb at least part of the blue emission, or at least part of the green light, or both at least part of the blue emission and at least part of the green light and to emit red light; a transmissive ceramic layer 205, arranged to transmit at least part of the blue emission, wherein the transmissive ceramic layer 205 comprises at least part of the green luminescent material or at least part of the red luminescent material or comprises at least part of the green luminescent material and at least part of the red luminescent material; can be used to generate (white) light 250. The LED package 200 is especially arranged to generate white light 250.

As mentioned above, the ceramic layer 205 may convert at least part of the emission light 249 into light of another color, for instance green light. When the ceramic layer 205 comprises the red luminescent material, and when the green luminescent material is arranged upstream from the ceramic layer, the red luminescent material may be arranged to absorb at least part of the green light, or at least part of the blue emission of the LED, or both absorb at least part of the green light and at least part of the blue emission.

The ceramic layer 205 will in general be a substantially flat plate, arranged with the light receiving surface 261 parallel to the light emitting surface 202 of the LED 201. Especially, the light receiving surface 261 and the light emitting surface 262 of the ceramic layer 205 are substantially parallel with light emitting surface 202 of the LED 201.

Have schematically explained how LED package 200 may provide substantially white light 250, now some embodiments of the LED package are further schematically depicted.

FIG. 2b schematically depicts an embodiment of LED package 200, wherein the LED package 200 comprise ceramic layer 205 and luminescent material layer 206, wherein the latter is downstream of the ceramic layer 205. In the schematic drawing of figure 2b, the ceramic layer 205 is attached to the light emitting surface 202; however, intermediate layers, such as optically active layers, or adhesive layers, may be present. Further, in the schematic drawing of FIG. 2b, the luminescent layer 206 is attached to the ceramic layer 205; however, intermediate layers, such as optically active layers, or adhesive layers, may be present. The luminescent layer 206 or the ceramic layer 205 or both may comprise the red luminescent material. Likewise, the luminescent layer 206 or the ceramic layer 205 or both may comprise the green luminescent material.

In the embodiment of schematic drawing 2b, the ceramic layer 205 comprises the green luminescent material, indicated with reference 203, and the luminescent material layer 205 comprises the red luminescent material 204. In this schematic figure of an embodiment, the luminescent layer 206 receives light escaping from ceramic layer through the light emitting surface 262 of the ceramic layer 205. The light escaping from the ceramic layer 205 will in this embodiment comprise blue LED light and green light from the green luminescent material 203 in the ceramic layer 205. The red luminescent material 204 may convert at least part of the blue LED emission 249 and/or at least part of the green light from the green luminescent material 203. The red luminescent material 204 is arranged to emit red light.

The schematic drawing of the embodiment of FIG. 2b further comprises an optional dome or lens 210. Such dome may comprise silicone material, and can further be used as protection of the LED 201, especially the light emitting surface 202 and other components as the ceramic layer 205. Especially, the dome 210 may be arranged to extract light more efficiently from the LED package 200 and/or to generate a preferred radiation pattern.

The embodiment of schematic drawing 2c is the same as the embodiment as schematically depicted in FIG. 2b, except for the fact that the luminescent layer 206 is absent and the ceramic layer 205 comprises both the green luminescent material 203 and the red luminescent material 204.

The embodiment of schematic drawing 2d is the same as the embodiment as schematically depicted in FIG. 2b, except for the fact that the luminescent layer 206 is upstream of the ceramic layer 205, whereas in FIG. 2b, the luminescent layer 206 was downstream of the ceramic layer 205.

The embodiment of schematic drawing 2e is the same as the embodiment as schematically depicted in FIG. 2b, except for the fact that the luminescent layer 206 is absent and a first 205(1) and a second ceramic layer 205(2) are arranged to the LED 201. The first ceramic layer 205(1) or the second ceramic layer 205(2) or both may comprise the red luminescent material. Likewise, the first ceramic layer 205(1) or the second ceramic layer 205(2) or both may comprise the green luminescent material. In the embodiment of schematic drawing 2e, the first ceramic layer 205(1) comprises the red luminescent material 204, and the second ceramic layer 205(2) comprises the green luminescent material 203. Here, in this schematic drawn embodiment, the second ceramic layer 205(2) is upstream of the first ceramic layer 205(1). As mentioned above, between the light emitting surface 202 and the (second) ceramic layer 205(2) and/or between the second 205(2) and the first ceramic layer 205(1) optional further layers may be present.

FIG. 2f schematically depicts an embodiment wherein at least part of the luminescent material (green, red, or green+red) is comprised by the ceramic layer 205 and at least part of the luminescent material (green, red, or green+red) is comprised in the lens or dome 210. In the schematic drawing, as preferred example the ceramic layer 205 comprises the green luminescent material 203, and the dome 210 comprises the red luminescent material 204. In this way, the source of blue light, here LED 201 is arranged to emit blue emission, the green luminescent material 203 is arranged to absorb at least part of the blue emission and to emit green light, the red luminescent material 204 is arranged to absorb at least part of the blue emission (not absorbed by (the luminescent material in) the ceramic layer 205) and/or at least part of the green light and to emit red light, and the transmissive ceramic layer 205 is arranged to transmit at least part of the blue emission (which at least partially escapes from the ceramic layer 205 via emitting surface 262 of the ceramic layer 205) and comprises the green luminescent material 203; which all together may lead to the generation of white light 250 during use of the LED package 200. In the schematic embodiment of FIG. 2f, the dome 210 comprises the red luminescent material 204, whereas the ceramic layer 205 comprises the green luminescent material 203.

FIG. 2g schematically depicts an embodiment wherein at least part of the luminescent material (green, red, or green+red) is comprised by the ceramic layer 205 and at least part of the luminescent material (green, red, or green+red) is comprised in a specific part 215 of the lens or dome 210. For instance, the LED package 200 comprises ceramic layer 205 attached to the LED 201 (optionally including further layer(s) arranged between the light emitting surface 202 of the LED 201 and the light receiving surface 261 of the ceramic layer 205), a first enclosure (such as a layer, dome or disk) 230, substantially enclosing the ceramic layer 205 (but not substantially enclosing light receiving surface 261), thereby receiving substantially all light transmitted and emitted by the ceramic layer 205, and dome 210, substantially enclosing the first enclosure 230, thereby receiving substantially all light transmitted and emitted by the first enclosure 230. In the schematic drawing of FIG. 2g, as preferred example the ceramic layer 205 comprises the green luminescent material 203, and the first dome 230 comprises the red luminescent material 204. In this way, the source of blue light, here LED 201 is arranged to emit blue emission, the green luminescent material 203 is arranged to absorb at least part of the blue emission and to emit green light, the red luminescent material 204 is arranged to absorb at least part of the blue emission (not absorbed by (the luminescent material in) the ceramic layer 205) and/or at least part of the green light and to emit red light, and the transmissive ceramic layer 205 is arranged to transmit at least part of the blue emission and comprises the green luminescent material 203; which all together may lead to the generation of white light during use of the LED package 200.

The embodiment schematically depicted in FIG. 2h is substantially the same as the embodiment schematically depicted in FIG. 2f, with the exception that at least part of the luminescent material (is not contained in the dome or lens 210 but) is arranged as luminescent material layer 206 on at least part of the external surface of the lens or dome 210. This outer layer with luminescent material is indicated as coating 211. In the embodiment schematically depicted in FIG. 2h, the ceramic layer 205 comprises the green luminescent material 203 and the coating 211 comprises the red luminescent material 204. However, this may also be arranged the other way around. And, as mentioned above, also mixtures of luminescent materials may be applied in the ceramic layer 205, in the luminescent layer 206 (here coating 211), or in both the ceramic layer 205 and the luminescent layer 206.

FIG. 2i schematically depicts another embodiment, wherein the LED package 200 further comprises a light guide 220, such as a collimator or a light pipe, which may especially be arranged to receive (guide) substantially all light 249 of LED 201, and wherein, the light guide 220 is further arranged to collimate or guide the light onto or in the direction of at least part of the ceramic layer 205, i.e. in the direction of at least part of light receiving surface 261 of the ceramic layer 205, which is arranged at the distance L1 from the light emitting surface 202. The light guide 220 is especially arranged in such a way that substantially no light 249 from the LED 201 escapes from the LED without being guided by light guide 220 in the direction of the ceramic layer 205; i.e. substantially no light 250 by the LED package 200 is generated that is not generated by or transmitted through the ceramic layer 205 (note that especially here, light 250 is a combination of the components blue LED emission, green light from the green luminescent material 203 and red light of the red luminescent material 204). Here, the term “transmitted” means that light entering the ceramic layer 205 at the light receiving surface 261 (i.e. the upstream side of the ceramic layer 205) is at least partially transmitted through the ceramic layer 205 (partially it may also be absorbed and converted into light of another wavelength and partially it may also be absorbed and lost due to non-radiative processes) and escapes (at least partially, see above) from the ceramic layer 205 via emitting surface 262. Therefore, the light emitting surface 202 of the LED 201 is especially enclosed by the light guide wall, indicated with reference 221; likewise, the ceramic layer 205 may in an embodiment be attached to the light guide wall 221, but may in another embodiment also be arranged in front of the light guide opening 222. Optionally, a lens or dome 210 may be present.

The luminescent materials 203,204 may be arranged at several places. For instance, at least part of the luminescent material may be arranged in or on the dome 210 (see also above), at least part of the luminescent material may be arranged as luminescent layer on the light emitting surface 202 of the LED 201, at least part of the luminescent material may be arranged as layer at the upstream side of the ceramic layer 205, at least part of the luminescent material may be arranged at the downstream side of the ceramic layer 205, and at least part of the luminescent material may be arranged at least part of the light guide wall 221. Combinations of two or more of these options are also possible. At least part of the luminescent material, especially the garnet material, is comprised by the ceramic layer 205.

In the schematic drawing of FIG. 2h, the ceramic layer 205 comprises the green luminescent material 203 and the LED package further comprises a luminescent material layer 206, arranged upstream of the ceramic layer 205, which luminescent material layer comprises here the red luminescent material 204.

Preferably, the light guide wall 221 comprises at least partly a metal or ceramic material, has a substantial thickness to enable heat transport, and is in thermal contact with the ceramic layer 205, to conduct heat, generated in one or more of the luminescent materials, away from these luminescent materials and to transfer the heat to ambient or to a further heat sink material. Heat sinks and heat sink materials are known in the art, and are not further depicted.

In an alternative embodiment of the invention, the light guide 220 comprises a solid, e.g. glass, (fused) quartz glass, or ceramic, e.g. sapphire, indicated as light guide 235, which may especially be mounted upstream of the ceramic layer 205 and downstream of the light emitting surface 202 of the LED 201 to guide the light emitted from the light emitting surface 202 to the ceramic layer 205. The light guide 235 may be arranged such that substantially all light emitted 250 from the LED package 200 is transmitted through or converted and emitted by the ceramic layer 205. This embodiment is schematically depicted in FIG. 2j. Such glass, (fused) quartz glass, or ceramic, e.g. sapphire does substantially not comprise luminescent material.

In all embodiments described above, and depicted in the schematic FIGS. 2a-2j, the ceramic layer 205 is substantially parallel with the light emitting surface 202 of the LED 201, i.e. the emitting 202 surface of the LED 201 and the light receiving surface 261 and the light emitting surface 262 of the ceramic layer 205 are substantially parallel.

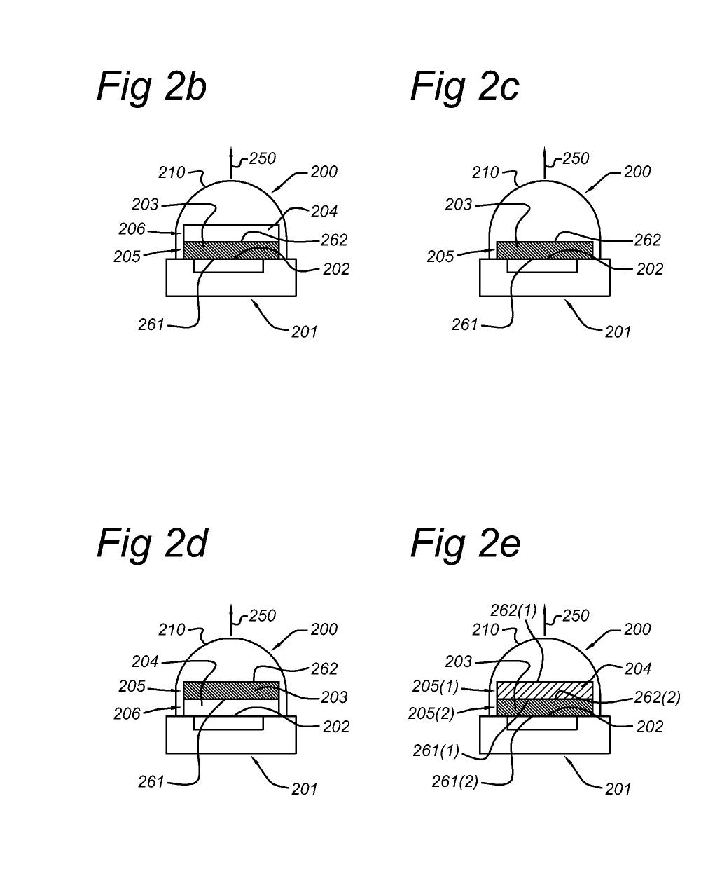

FIG. 3 depicts an LCD TV performance with a backlight illumination device 20 according to embodiments of the invention, wherein the LED packages 200 are arranged as schematically depicted in FIG. 2f, and wherein the ceramic layer 205 comprises a green luminescent material 203 selected from the group consisting of Lu₃Al₅O₁₂:Ce (refs. 307-309) and (Lu_{0.2}Y_{0.8})₃A1₅O₁₂:Ce (refs 310-312), in relation to “reference” LED packages wherein as green luminescent powder SrSi₂N₂O₂:Eu powder (refs 304-306) or Lu₃Al₅O₁₂:Ce powder (refs 301-303) in the dome 210 is applied. In all case as red luminescent material 204 CaAlSiN₃:Eu was applied, which was in all examples arranged within the dome 210.

The backlight illumination device 20, including conventional color filters, generated white light with a correlated color temperature (CCT) of about 9000 K. A Sharp panel LC-32RA1E was applied. For an overview of the luminescent material—LED combinations, see table 1 below.

TABLE 1
references in relation to FIG. 3

| | LED peak | | In | | Red luminescent |
|---|---|---|---|---|---|
| Reference | emission | Green luminescent | dome | In ceramic | material 204 (in |
| number | wavelength (nm) | material 203 | 210 | layer 205 | dome 210) |
| 301 | 440 | Lu₃Al₅O₁₂: Ce powder | Yes | No | CaAlSiN₃: Eu |
| | | | | | powder |
| 302 | 445 | Lu₃Al₅O₁₂: Ce powder | Yes | No | CaAlSiN₃: Eu |
| | | | | | powder |
| 303 | 450 | Lu₃Al₅O₁₂: Ce powder | yes | No | CaAlSiN₃: Eu |
| | | | | | powder |
| 304 | 440 | SrSi₂N₂O₂: Eu powder | Yes | No | CaAlSiN₃: Eu |
| | | | | | powder |
| 305 | 445 | SrSi₂N₂O₂: Eu powder | Yes | No | CaAlSiN₃: Eu |
| | | | | | powder |
| 306 | 450 | SrSi₂N₂O₂: Eu powder | Yes | No | CaAlSiN₃: Eu |
| | | | | | powder |
| 307 | 440 | Lu₃Al₅O₁₂: Ce | No | Yes | CaAlSiN₃: Eu |
| | | | | | powder |
| 308 | 445 | Lu₃Al₅O₁₂: Ce | No | Yes | CaAlSiN₃: Eu |
| | | | | | powder |
| 309 | 450 | Lu₃Al₅O₁₂: Ce | No | Yes | CaAlSiN₃: Eu |
| | | | | | powder |
| 310 | 440 | (Lu_{0.2}Y_{0.8})₃Al₅O₁₂: Ce | No | Yes | CaAlSiN₃: Eu |
| | | | | | powder |
| 311 | 445 | (Lu_{0.2}Y_{0.8})₃Al₅O₁₂: Ce | No | Yes | CaAlSiN₃: Eu |
| | | | | | powder |
| 312 | 450 | (Lu_{0.2}Y_{0.8})₃Al₅O₁₂: Ce | No | Yes | CaAlSiN₃: Eu |
| | | | | | powder |

Note with respect to Table 1: the dominant wavelength of light emitted by a blue light emitting diode is typically 3 to 10 nm larger than the peak wavelength (i.e. maximum wavelength) of the emitted spectrum, depending on the spectral shape and the spectral position of the emission.

With the Lu garnets as ceramic layers 205, both efficacy and gamut increase relative to Lu garnet powder. By varying the Lu content, it can be chosen between high efficacy and high color gamut (see area enclosed by dashed line). With the Lu garnet as ceramic layer 205, a specification of 85% gamut area relative to u′ v′ NTSC can easily be achieved at high efficacy, whereas with non-ceramic layer applications, either the efficacy and/or the gamut area are smaller. In an embodiment, especially garnets are chosen, wherein the A ion comprises in the range of 50-100% Lu (not including Ce).

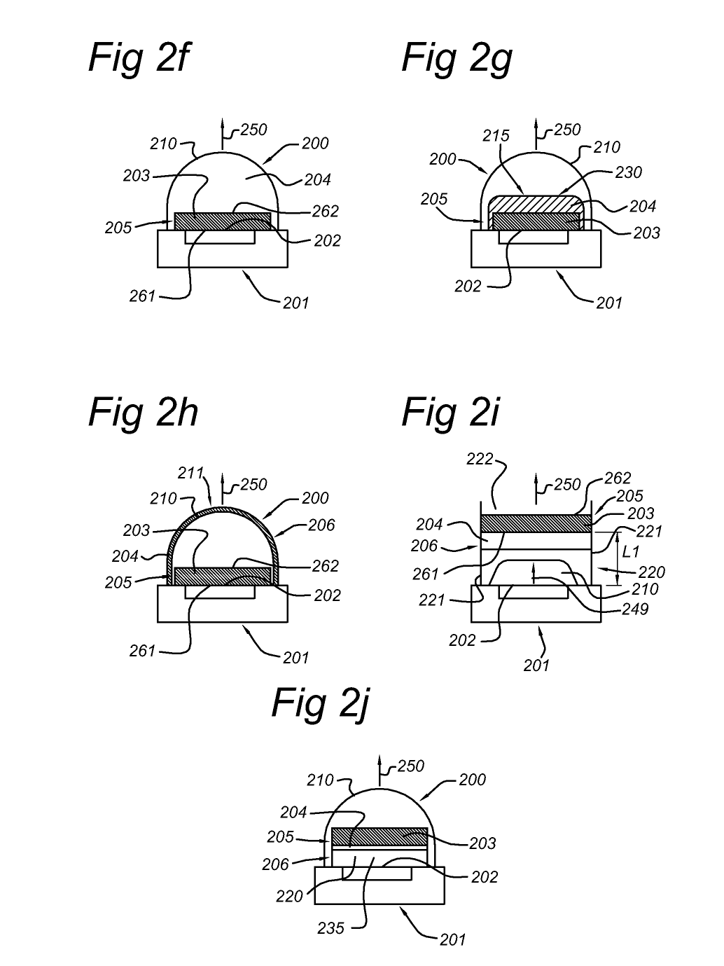

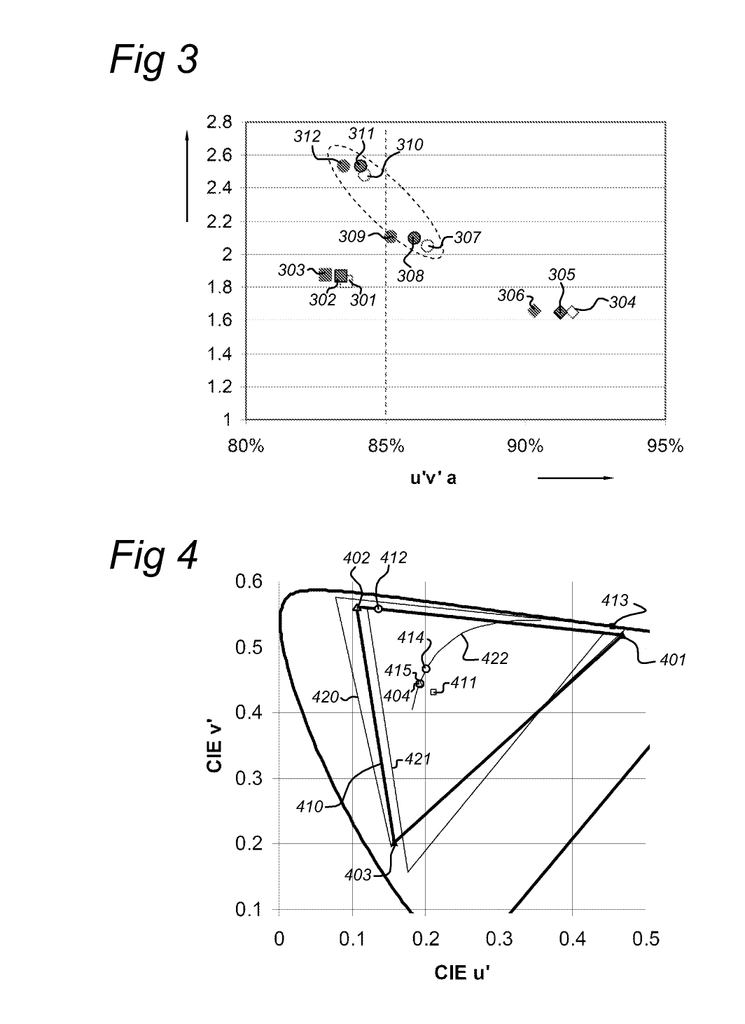

The results for some examples are further depicted in FIGS. 4 and 5. FIG. 4 depicts the color gamut of a 9000K Front-of-Screen (FOS) LCD TV Sharp 32″ (LC-32RA1E), with a blue dominant emission at 445 nm with a ceramic layer 205 of Lu₃Al₅O₁₂:Ce and with a red luminescent material 204 of CaAlSiN₃:Eu powder (see also reference 308 in FIG. 3 and the table 1 above). FIG. 5 depicts the color gamut of a 9000K FOS LCD TV Sharp 32″ (LC-32RA1E), with a blue dominant emission at 445 nm with a ceramic layer 205 of (Lu_{0.2}Y_{0.8})₃A1₅O₁₂:Ce and with a red luminescent material 204 of CaAlSiN₃:Eu powder (see also reference 311 in FIG. 3 and the table 1 above). In table 2, the references in relation to FIGS. 4 and 5 are indicated.

TABLE 2
references in relation to FIGS. 4 and 5

| Reference | |
|---|---|
| number | Explanation |
| 401 | Red FOS color point |
| 402 | Green FOS color point |
| 403 | Blue FOS color point |
| 404 | White FOS color point |
| 410 | Color gamut |
| 411 | Backlight emission |
| 412 | Green light |
| 413 | Red light |
| 414 | T_{c} = 6500 K |
| 415 | T_{c} = 9000 K |
| 420 | NTSC standard color gamut |
| 421 | EBU standard color gamut |
| 422 | Planckian locus (BBL) |

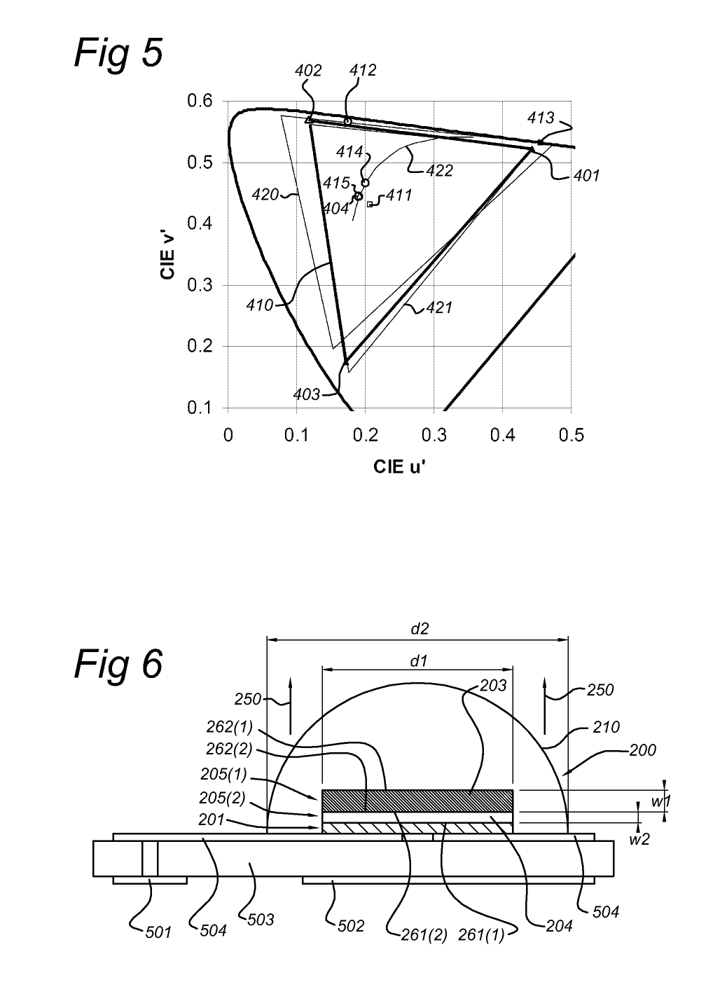

In FIG. 6 schematically an embodiment of the LED package 200 of the invention is depicted in more detail. On top of the LED 201 with light emitting surface 202, a ceramic layer stack comprising the first ceramic layer 205(1) and a second ceramic layer 205(2), the latter arranged downstream of the former. In this embodiment, the first ceramic layer 205(1) comprises the green luminescent material 203 and the second ceramic layer 205(2) comprises the red luminescent material 204, such as a Lu containing garnet. The LED 201 and the ceramic layer stack are enclosed by the lens or dome 210. The LED further comprises electrodes 504, a substrate 503, especially a ceramic substrate (such as Al₂O₃ or AlN), a thermal pad 502, arranged to the substrate 503, and a solder pad 501 for electrical connection (anode/cathode).

Note that instead of second ceramic layer 205(2) a luminescent material layer 206 may be applied, which may for instance comprise the red luminescent material 204.

The light emitting surface 202 of the LED in the above embodiments may have dimensions such as length and width, here indicated with reference d1, in the order of about 0.5-1.0 mm; the dome 210 may have dimensions in the order of about 1.5-3.0 mm, indicated with reference d2. The light emitting surface 202 will in general be square, whereas the dome 210 will in general be spherical. The light receiving surface 261 may have dimensions equal to the light emitting surface 202 of the LED 201 or larger.

Referring to FIG. 6, the width w1 of the first ceramic layer 205(1) may be in the range of about 0.05-0.3 mm; the width w2 of the second ceramic layer 205(2) may be in the range of about 0.05-0.25 mm.

When using a single ceramic layer, such as schematically depicted in FIGS. 2a, 2b, 2c, 2d, 2f, 2g, 2h, 2i, and 2j, especially a Lu-garnet ceramic layer, the width of such ceramic layer 205 will in general be in the range of 0.05-0.3 mm, especially 0.07-0.2 mm. The width of the red luminescent layer 206 (being upstream or downstream from the ceramic layer 205) may be in the range of about 0.01-0.1 mm, preferably in the range of about 0.015-0.03 mm.

### Specific Embodiments for Lighting Purposes

Below, some specific embodiments for non-backlighting purposes, such as general lighting or for task lighting, for spot lighting, for area lighting, or for direct view lighting panels, are described in more detail.

In such embodiments, a (LuₓY₁₋ₓ)₃Al₅O₁₂:Ce ceramic phosphor is preferred with about 0.2<x<1, in combination with a red emitting phosphor (either as ceramic plate or based on powder application) with a dominant peak wavelength in the range from about 615 to 645 nm, more preferably in the range from about 620 to 635 nm.

For color temperatures in the range from about 2500 to 3300K, a Lu concentration with about 0.25≦x≦0.8 is preferred. For color temperatures in the range from about 3500 to 4500K, a Lu concentration with about 0.3≦x≦0.8 is preferred. For color temperatures in the range from about 5500 to 7500K, a Lu concentration with about 0.4≦x≦1 is preferred; a preferred concentration is about 0.5≦x≦0.9.

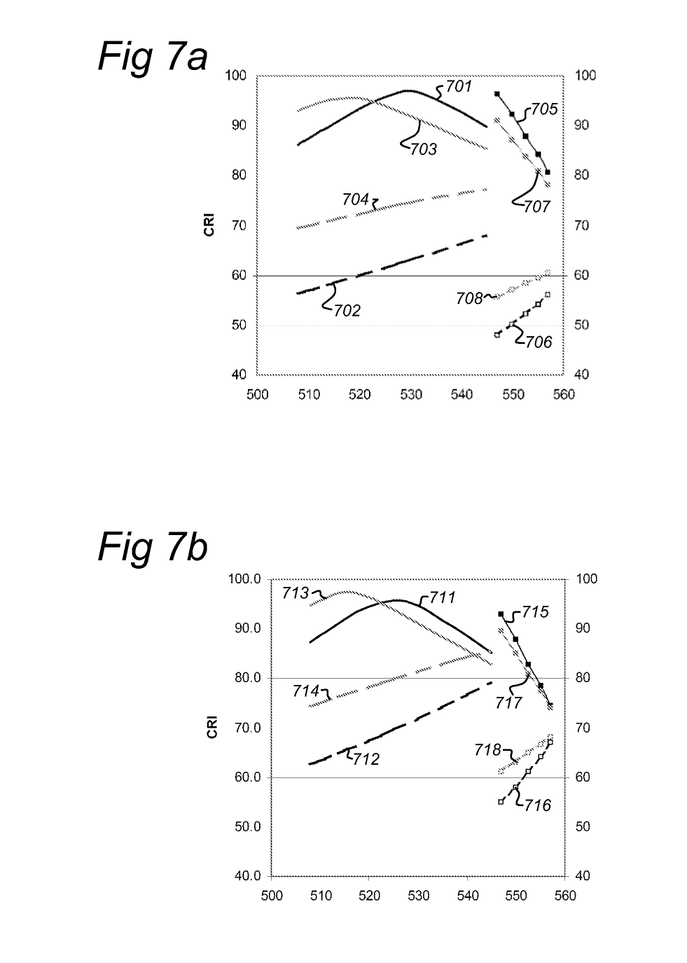

An example for 4000 K is shown in FIGS. 7a and 7b; the left y-axis indicates the CRI and the right y-axis indicates the relative efficacy. A LED configuration according to 2d was used, with CaAlSiN₃:Eu powder as red luminescent material, and with a LuYAG ceramic luminescent plate 205 as the yellow/green emitter.

In table 3, the references in relation to FIGS. 7a (2700 K) and 7b (4000 K) are indicated.

TABLE 3
references in relation to FIG. 7a and 7b

| | | | |
|---|---|---|---|
| | | | Peak maximum |
| Reference | | | red luminescent |
| number | Reference number | Powder/ceramic material | material |
| (CRI) | (relative efficacy) | (LuₓY₁₋ₓ)₃Al₅O₁₂:Ce | (nm)¹ |

FIG. 7a; 2700 K

| | | | |
|---|---|---|---|
| 701 | 702 | Ceramic material | 648 |
| 703 | 704 | Ceramic material | 631 |
| 705 | 706 | Powder | 648 |
| 707 | 708 | Powder | 631 |

FIG. 7b; 4000 K

| | | | |
|---|---|---|---|
| 711 | 712 | Ceramic material | 648 |
| 713 | 714 | Ceramic material | 631 |
| 715 | 716 | Powder | 648 |
| 717 | 718 | Powder | 631 |

¹dominant emission wavelength is about 5 nm smaller

Within the curves shown in FIGS. 7a and 7b, the x value (Lu content) is varied; the resulting emission wavelength (peak maximum) is indicated on the x-axis.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. For instance, the phrase “the ceramic substantially consisting of garnet material” and similar phrases, may in an embodiment also relate to a garnet ceramic, i.e. a ceramic made of garnet (“the ceramic consisting of garnet material”). Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. For instance, the ceramic layer 205 may comprise the green luminescent material 203, may refer to a green luminescent material ceramic.

The devices herein are amongst others described during operation. For instance, the term “blue LED” refers to an LED which during operation thereof generates blue light; in other words: the LED is arranged to emit blue light. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-16. (canceled)

17. A display device comprising a liquid crystal display (LCD) panel and a backlight illumination device configured to backlight the LCD panel, wherein the backlight illumination device comprises a light emitting diode package for generating white light, the light emitting diode package comprising:
a light emitting diode configured to emit blue emission;
a green luminescent material configured to absorb at least part of the blue emission and to emit green light,
a red luminescent material configured to absorb at least part of the blue emission and/or at least part of the green light and to emit red light; and
a transmissive ceramic layer configured to transmit at least part of the blue emission and comprising at least a portion of the green luminescent material and/or at least a portion of the red luminescent material, wherein the transmissive ceramic layer comprises a A₃B₅O₁₂:Ce garnet ceramic, wherein A comprises at least lutetium (Lu) and wherein B comprises at least aluminum (Al).

18. The display device according to claim 17, wherein the LED is configured to generate blue light with a dominant emission wavelength in the range of 430-455 nm.

19. The display device according to claim 17, wherein the transmissive ceramic layer comprises a (Y₁₋ₓLuₓ)₃B₅O₁₂:Ce garnet ceramic, wherein 0<x≦1.

20. The display device according to claim 17, wherein the red luminescent material comprises one or more materials selected from the group consisting of: (Ba,Sr,Ca)S:Eu, CaAlSiN₃:Eu and (Ba,Sr,Ca)₂Si₅N₈:Eu.

21. The display device according to claim 17, wherein the red luminescent material is arranged, relative to the LED, downstream of the LED and upstream of the transmissive ceramic layer.

22. The display device according to claim 17, wherein the transmissive ceramic layer has an upstream side coating comprising the red luminescent material.

23. The display device according to claim 17, comprising a plurality of light emitting diode packages, and a controller configured to control the intensity and/or color of the white light generated by at least one of the plurality of light emitting diode packages.

24. The display device according to claim 17, wherein the red luminescent material comprises CaAlSiN₃:Eu.

25. The display device according to claim 17, wherein the red luminescent material has an emission with a dominant emission wavelength in the range of 620-635 nm.
